(19) United States
(12) Patent Application Publication
(10) Pub. No.: US 2026/0362134 A1
(43) Pub. Date: Nov. 12, 2026

(54) METHODS AND APPARATUS FOR WTRU-NF/AF AUTHENTICATION AND AUTHORIZATION WITH TOKEN

(71) Applicant: InterDigital Patent Holdings, Inc., Wilmington, DE (US)

(72) Inventors: Zhibi Wang, Woodridge, IL (US); Samir Ferdi, Kirkland (CA); Yi Zhang, San Jose, CA (US); Chonggang Wang, Princeton, NJ (US); Alec Brusilovsky, Downingtown, PA (US)

(73) Assignee: InterDigital Patent Holdings, Inc., Wilmington, DE (US)

(21) Appl. No.: 19/202,757

(22) Filed: May 8, 2025

(51) Int. Cl. H04W 12/06; H04L 9/32; H04W 12/04

(52) U.S. Cl. CPC H04W 12/06; H04L 9/3213; H04W 12/04; H04L 2209/80

(57) ABSTRACT

Systems and methods for establishing a WTRU connection with an NF/AF using authentication and authorization token are described. Methods may include: the WTRU transmitting an authorization token request to a key management function (KMF) for accessing communication with a network function or an application function (NF/AF); receiving a response from the KMF comprising an authorization token granting access to communication with the NF/AF; establishing a secure user plane connection with the NF/AF based on the authorization token; transmitting a resource request to the NF/AF using the authorization token; and receiving a response from the NF/AF.

### BACKGROUND

Current wireless network systems lack support for adequate security isolation, for example, in scenarios where the access and mobility management function (AMF) is common to multiple network slices. Current systems also lack security differentiation, for example, in one size fits all approaches such as in non-access stratum (NAS) level security serving and/or being applicable to all network functions (NFs) and/or services.

In some systems, WTRU-NF/application function (AF) communication provides only a per NF based authorization that is fine grain controlled based on the detail resource and scope on the resource owner. Moreover, location service (LCS) procedures may not support mutual authentication and the location management function (LMF) does not authenticate the WTRU. Instead, the procedures may use an intricate protocol for binding the transport layer security (TLS) connection to the WTRU via the NAS connection and AMF assistance using a binding ID allocated by the LMF. In addition, there is no fine grained authorization mechanism when a WTRU accesses the NF/AF. Once the WTRU obtains an access token for the NF/AF, it can access all services provided by the NF/AF with fine granularity such as specific data record, perform a limited operations, within a specific time duration. This approach lacks security differentiation for the various services offered by the NF/AF.

In some systems, WTRU state information is distributed across various NFs (for example: AMF, session management function (SMF), and unified data management (UDM)). The reliance on stored WTRU state information among NFs may lead to unnecessary coupling between the NFs and excess signaling during procedures. This issue may hinder system ability to scale to support a foreseen multiplication in the number of devices and device types (for example, artificial intelligence of things (AIoT), intelligent vehicles, and uncrewed aerial vehicles (UAVs)) that may use wireless services.

### SUMMARY

Embodiments include methods for use in a wireless transmit/receive unit (WTRU), the method comprising: transmitting an authorization token request to a key management function (KMF) for accessing communication with a network function or an application function (NF/AF); receiving a response from the KMF comprising an authorization token granting access to communication with the NF/AF; establishing a secure user plane connection with the NF/AF based on the authorization token; transmitting a resource request to the NF/AF using the authorization token; and receiving a response from the NF/AF. Additionally/alternatively the methods may include wherein the authorization token request includes at least one of: an NF/AF identification (ID), a resource to access, scope of the resource request, or duration of the resource request. Additionally/alternatively the methods may include wherein the authorization token includes at least one of: a granted scope of the requested resource, the NF/AF ID or an expiration time of the requested resource. Additionally/alternatively the methods may include wherein the response from the KMF further comprises a refresh token. Additionally/alternatively the methods may include wherein the response from the KMF further comprises at least one of a scope parameter, a token type, a token lifetime. Additionally/alternatively the methods may include wherein the response from the NF/AF includes results of a service requested by the WTRU. Additionally/alternatively the methods may include the WTRU performing a primary authentication with the network prior to transmitting the authorization token request. Additionally/alternatively the methods may include receiving from the KMF a root key and a unique key identifier. Additionally/alternatively the methods may include requesting an authentication token from the KMF; and receiving the authentication token. Additionally/alternatively the methods may include generating an authentication token based on a session ID, a WTRU ID and a time stamp using a key derived from a key (K_{KMF}) shared with the KMF.

Embodiments include a wireless transmit/receive unit (WTRU) comprising: a processor and a transceiver, wherein the processor and transceiver are configured to: transmit an authorization token request to a key management function (KMF) for accessing communication with a network function or an application function (NF/AF); receive a response from the KMF comprising an authorization token granting access to communication with the NF/AF; establish a secure user plane connection with the NF/AF based on the authorization token; transmit a resource request to the NF/AF using the authorization token; and receive a response from the NF/AF. Additionally/alternatively the WTRU may include wherein the authorization token request includes at least one of: an NF/AF identification (ID), a resource to access, scope of the resource request, or duration of the resource request. Additionally/alternatively the WTRU may include wherein the authorization token includes at least one of: a granted scope of the requested resource, the NF/AF ID or an expiration time of the requested resource. Additionally/alternatively the WTRU may include wherein the response from the KMF further comprises a refresh token. Additionally/alternatively the WTRU may include wherein the response from the KMF further comprises at least one of a scope parameter, a token type, a token lifetime. Additionally/alternatively the WTRU may include wherein the response from the NF/AF includes results of a service requested by the WTRU. Additionally/alternatively the WTRU may include wherein the processor and transceiver are further configured to performing a primary authentication with the network prior to transmitting the authorization token request. Additionally/alternatively the WTRU may include wherein the processor and transceiver are further configured to receive from the KMF a root key and a unique key identifier. Additionally/alternatively the WTRU may include wherein the processor and transceiver are further configured to: request an authentication token from the KMF; and receive the authentication token. Additionally/alternatively the WTRU may include wherein the processor and transceiver are further configured to generate an authentication token based on a session ID, a WTRU ID and a time stamp using a key derived from a key (K_{KMF}) shared with the KMF.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example non-roaming 5G system architecture;

FIG. 3 is an example key hierarchy;

FIG. 4 an example WTRU-initiated user plane set up;

FIG. 5 an example hybrid system architecture;

FIG. 6 is a further example hybrid system architecture;

FIG. 7 is an example key hierarchy;

FIG. 8 is a further example key hierarchy;

FIG. 9 is an example WTRU to network function authentication and authorization process; and

FIG. 10 is a flow chart of an example process for WTRU to network function authentication and authorization.

### DETAILED DESCRIPTION

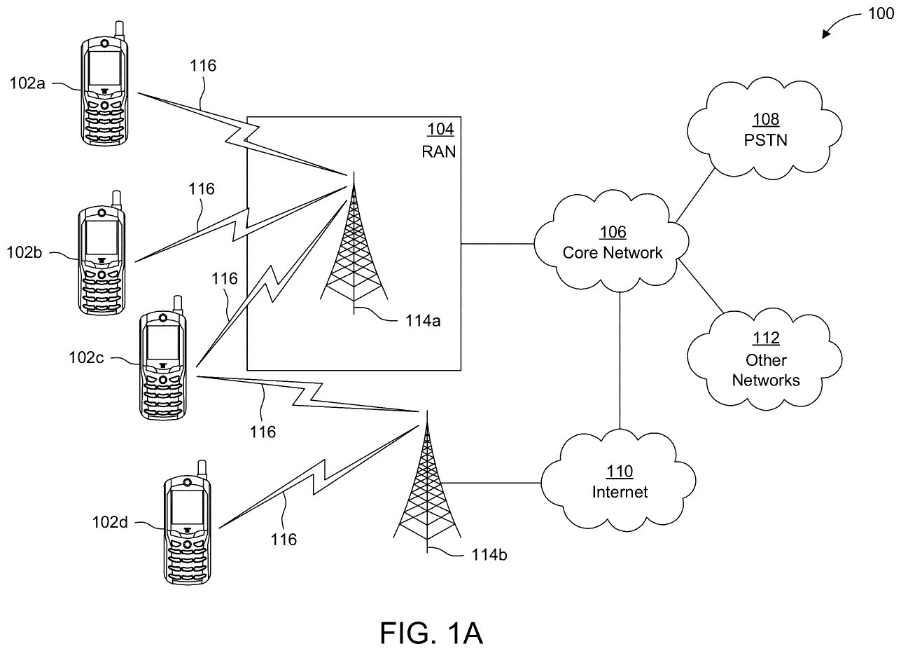

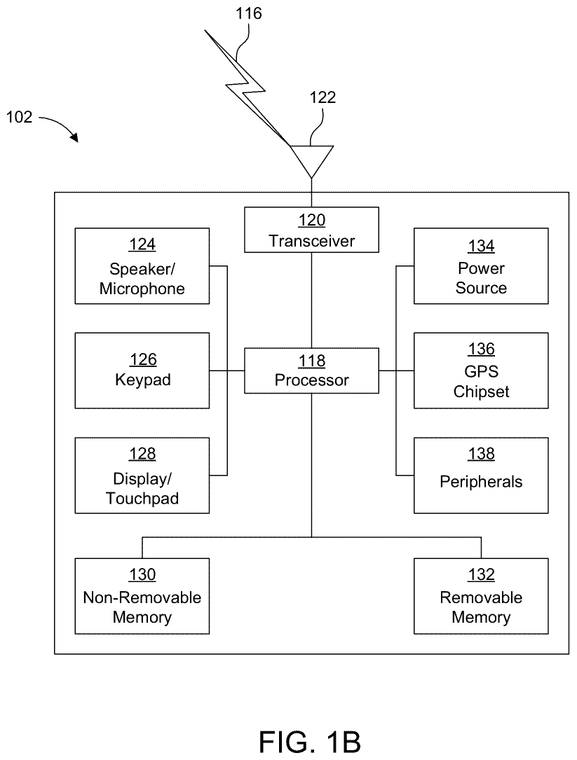

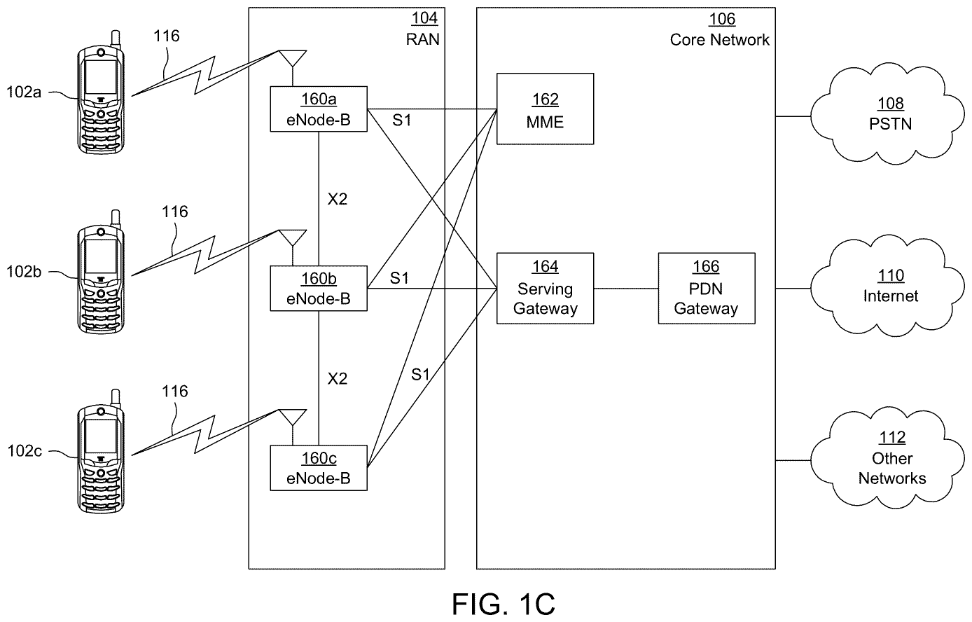

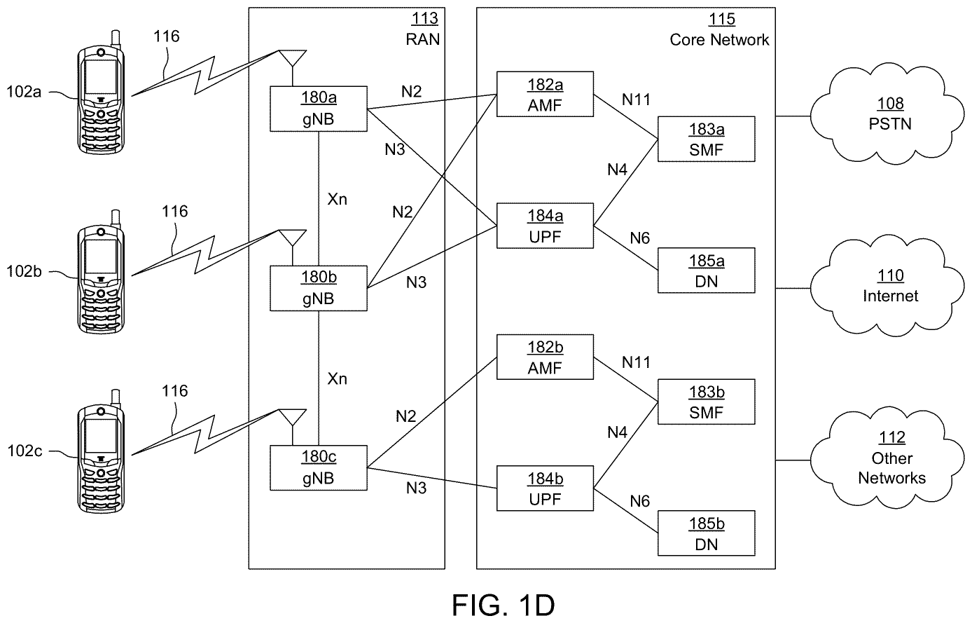

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms are used interchangeably throughout this written description. Where an acronym as stated in this listing conflicts with a definition of the same acronym in the text, the definition in the text shall control.
5GS 5G System
6GS 6G System
AKMA Authentication and Key Management for Applications
CP Control Plane
FQDN Fully Qualified Domain Name
GBA Generic Bootstrapping Architecture
KMF Key Management Function
ID Identifier
IE Information Element
LCS Location Services
MM Mobility Management
N4 Interface defined by 3GPP between SMF and UPF
NAI Network Access Identifier
NAS Non-Access Stratum
PCC Policy and Charging Control
PSK Pre-Shared Key
SEAF Security Anchor Function
SM Session Management
SBI Service-Based Interface
SPF SBI Proxy Function or Security Proxy Function
URSP WTRU Route Selection Policy

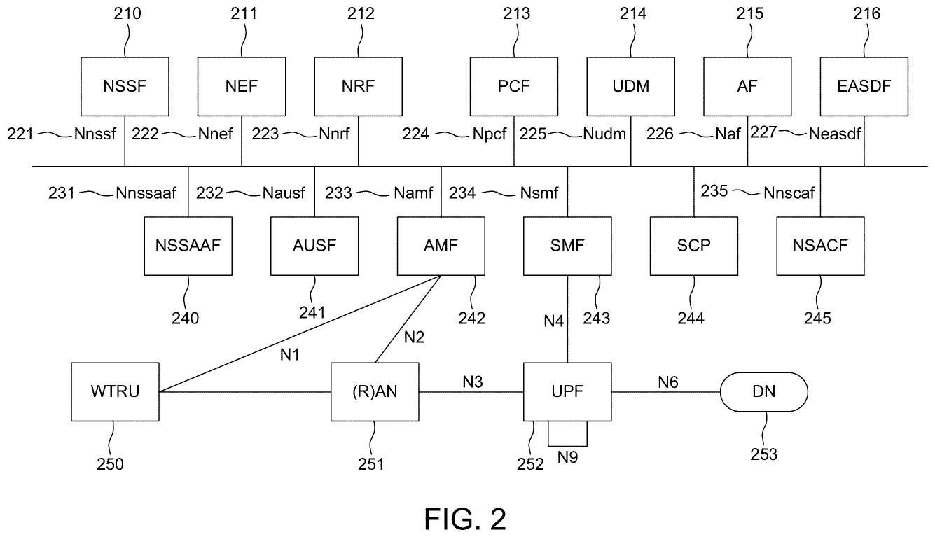

FIG. 2 is an example non-roaming system architecture. The following entities/functions and related service-based interfaces (titled Nxxx) are shown in FIG. 2: Network Slice Selection Function (NSSF) 210, Nnssf 221, Network Exposure Function (NEF) 211, Nnef 222, Network Repository Function (NRF) 212, Nnrf 223, Policy Control Function (PCF) 213, Npcf 224, Unified Data Management (UDM) 214, Nudm, 225, Application Function (AF) 215, Naf, 226, Edge Application Server Discovery Function (EASDF) 216, Neasdf 216, Network Slice-specific and SNPN Authentication and Authorization Function (NSSAAF) 240, Nssaaf 231, Authentication Server Function (AUSF) 241, Nausf 232, Access and Mobility Management Function (AMF) 242, Namf 233, Session Management Function (SMF) 243, Nsmf 234, Service Communication Proxy (SCP) 244, Network Slice Admission Control Function (NSACF) 245, Nnsacf 235, WTRU 250, Radio Access Network (RAN) 251, User Plane Function (UPF) 252, Data Network (DN) 253.

In embodiments, all NAS signaling between the WTRU 250 and the core network (5GC) terminates at the AMF 242 (shown as the N1 interface in FIG. 2). A WTRU communicates with other 5GC NFs (e.g., SMF 243) using NAS transport via het AMF by means of dedicated (for example, SM) transparent containers, which the AMF forwards over using the SBI (For example, invoking Nsmf service 234).

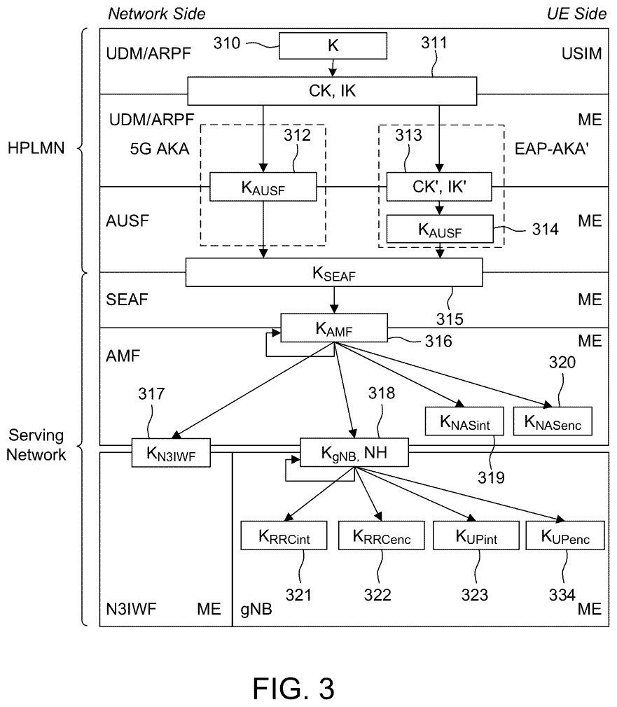

FIG. 3 is an example 5G key hierarchy. The NAS connection between the WTRU 250 and AMF 242 is secured using NAS keys (K_{NASint} 319, K_{NASenc} 320) derived from a K_{AMF} 316 established during WTRU primary authentication. The keys related to authentication include the following keys: K 310, CK/IK 311. In a case of EAP-AKA′, the keys CK′, IK′ 313 are derived from CK, IK. The key hierarchy FIG. 3 includes the following keys: K_{AUSF} 312, K_{SEAF} 315, K_{AMF} 316, K_{NASint} 319, K_{NASenc} 320, K_{N3IWF} 317, K_{gNB} 318, K_{RRCint} 321, K_{RRCenc} 322, K_{UPint} 323 and K_{UPenc} 324.

Keys for AUSF in the home network: K_{AUSF} is a key derived by ME and AUSF from CK′, IK′ in case of EAP-AKA′, CK′ and IK′ is received by AUSF as a part of transformed AV from ARPF; or, by ME and ARPF from CK, IK in case of 5G AKA, K_{AUSF} is received by AUSF as a part of the 5G HE AV from ARPF. K_{SEAF} is an anchor key derived by ME and AUSF from K_{AUSF}. K_{SEAF} is provided by AUSF to the SEAF in the serving network. Key for AMF in serving network: K_{AMF} is a key derived by ME and SEAF from K_{SEAF}. K_{AMF} is further derived by ME and source AMF when performing horizontal key derivation. Keys for NAS signaling: K_{NASint} is a key derived by ME and AMF from K_{AMF}, which shall only be used for the protection of NAS signaling with a particular integrity algorithm. K_{NASenc} is a key derived by ME and AMF from K_{AMF}, which shall only be used for the protection of NAS signaling with a particular encryption algorithm. Key for NG-RAN: K_{gNB} is a key derived by ME and AMF from K_{AMF}. K_{gNB} is further derived by ME and source gNB when performing horizontal or vertical key derivation. The K_{gNB} is used as K_{eNB} between ME and ng-eNB. Keys for UP traffic: K_{UPenc} is a key derived by ME and gNB from K_{gNB}, which shall only be used for the protection of UP traffic with a particular encryption algorithm. K_{UPint} is a key derived by ME and gNB from K_{gNB}, which shall only be used for the protection of UP traffic between ME and gNB with a particular integrity algorithm. Keys for RRC signaling: K_{RRCint} is a key derived by ME and gNB from K_{gNB}, which shall only be used for the protection of RRC signaling with a particular integrity algorithm. K_{RRCenc} is a key derived by ME and gNB from K_{gNB}, which shall only be used for the protection of RRC signaling with a particular encryption algorithm. Key for non-3GPP access: K_{N3IWF} is a key derived by ME and AMF from K_{AMF} for non-3GPP access. K_{N3IWF} is not forwarded between N3IWFs.

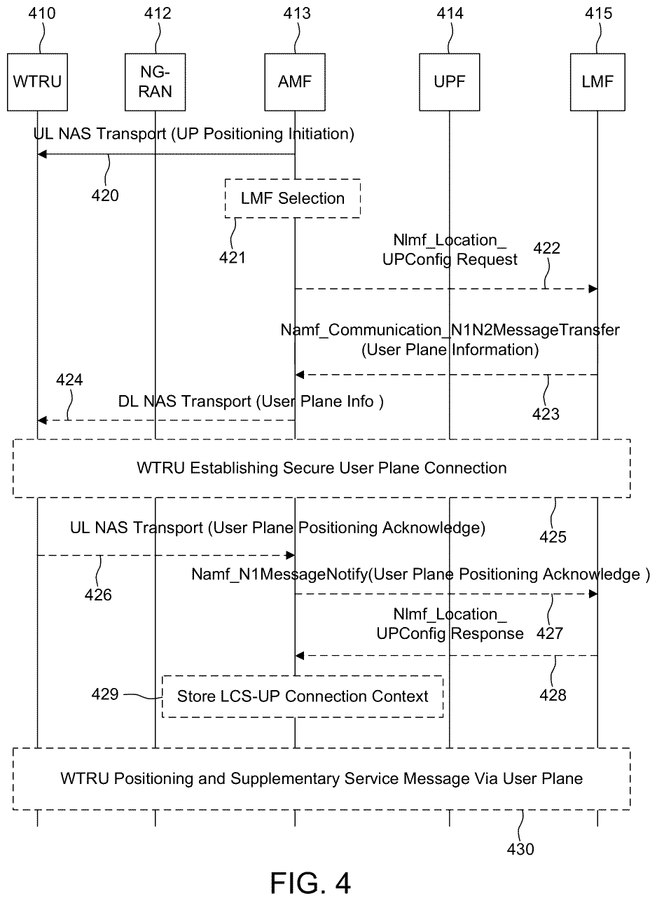

Mechanisms for communications over the user plane (UP) between a WTRU and a termination point in the 5GC (LMF) for the Location Services (LCS) feature are described herein. FIG. 4 illustrates an example procedure where a WTRU 410 initiates a UP connection establishment with the LMF 415 using (CP) NAS message exchange with the AMF 413. Also shown in FIG. 4 are the NG-RAN 412,and the UPF 414.

At 420, the WTRU 410 sends a user plane connection establishment request to the AMF 413 via a NAS Message, if there is no established secure user plane connection between the WTRU 410 and LMF 415 and the WTRU determines to request a user plane connection for upcoming positioning requests.

At 421, if the WTRU 410 is authorized based on a WTRU subscription to use the user plane positioning, the AMF 413 selects an LMF 415 which capable to establish a user plane session for positioning with the WTRU. The AMF may either query the NRF or based on local configuration discover and select a proper LMF.

At 422, the AMF 413 sends a Nlmf_Location_UPConfig Request towards the LMF to request set up of an LCS-UP connection. The AMF may include the target WTRU identity in the request.

At 423,if the LMF 415 accepts to utilize user plane for positioning and there is no established secure user plane connection between the WTRU and the LMF, the LMF sends user plane information to the AMF 413 to indicate the WTRU 410 is to accept and utilize user plane for positioning. The user plane information includes the user plane positioning address of the LMF. The LMF allocates a LCS-UP binding ID to associate the user plane connection to be established with the target WTRU and includes the LCS-UP binding ID in the user plane information. The LMF associates the target WTRU identity (SUPI and/or GPSI) with the LCS-UP binding ID.

At 424, when the AMF 413 receives the user plane information from LMF 415, the AMF forwards it to the WTRU via a DL NAS TRANSPORT message.

At 425, if there is no established secure user plane connection, the WTRU 410 establishes a secured user plane connection with the LMF 415. The WTRU uses the user plane positioning address of the LMF, together with the information in the URSP, to determine the PDU session parameters including DNN+S-NSSAI. UE uses the PDU session parameter to establish PDU session. When SMF receives the request, it selects a proper UPF based on the DNN+S-NSSAI, and establishes the connection between the UPF and LMF. After the secured user plane connection has been established successfully, the WTRU sends the LCS-UP binding ID received at 424 to the LMF via the secured user plane connection to enable the LMF to perform the correlation of the WTRU with this secured user plane connection. The LCS-UP binding ID will be released once the correlation is complete.

At 426,the WTRU 410 sends an acknowledgement to the LMF 415 through the AMF 413 to indicate a success of user plane connection establishment for positioning service or a failure to utilize the user plane connection.

At 427, the AMF 413 sends the acknowledgement received at 426 to the LMF 415 via the Namf_N1messageNotify service.

At 428, the LMF 415 responds to the AMF 413 that user plane connection between the WTRU 410 and LMF has been established.

At 429, the AMF 413 stores the LCS-UP connection context as part of the WTRU 410 context

At 430, after the secure user plane connection is established, if the LMF 415 determines to utilize the user plane connection for positioning after receiving a positioning request from the AMF 413, or the WTRU 410 determines to utilize the user plane connection for positioning, LPP messages are transferred between the WTRU and LMF for WTRU based positioning, WTRU assisted positioning and delivery of assistance data.

In embodiments an authorization framework (OAuth 2.0) that enables a third-party application to obtain limited access to resources on another service without exposing the user's credentials may be used. The framework focuses on granting permissions (authorization) and not on verifying the user's identity (authentication). OpenID Connect (OIDC) is an authentication protocol. OIDC provides an identity layer that enables client applications to verify the identity of an end-user based on the authentication performed by an authorization server. OIDC leverages the authorization flow of OAuth 2.0 but adds the concept of an ID Token (a security token containing claims about the user) to achieve authentication. 5GS systems may lack support for proper security isolation (for example, AMF is common to multiple network slices) or security differentiation (for example, NAS level security serving/applicable to all NFs/services).

The WTRU-NF/AF communication may only provide a per NF based authorization that fine grain controlled based on the detail resource and scope on the resource owner. LCS procedures do not support mutual authentication. The LMF does not authenticate the WTRU. Instead, the procedures use an intricate protocol for “binding” the TLS connection to the WTRU via the NAS connection and AMF assistance using a “binding ID” allocated by the LMF In addition, there is no fine grained authorization mechanism when a UE accesses the NF/AF. Once the WTRU obtains an access token for the NF/AF, it can access all services provided by the NF/AF with fine granularity such as specific data record, perform a limited operations, within a specific time duration, etc. The existing approach lacks security differentiation for the various services offered by the NF/AF.

Key functions may be inside the network, with WTRU state information typically distributed across various NFs (e.g., AMF, SMF, UDM). The reliance on stored WTRU state information among NFs leads to unnecessary coupling between the NFs, excess signaling during procedures. This issue may hinder the system ability to scale to support a foreseen multiplication in the number of devices and device types (e.g., AIoT, Intelligent Vehicles, UAVs) that will use 6GS services.

Systems and methods are describe herein to support a more modular and scalable approach for WTRU-NF/AF communications while supporting WTRU authentication directly and fine grained authorization for communication between the WTRU and an NF/AF.

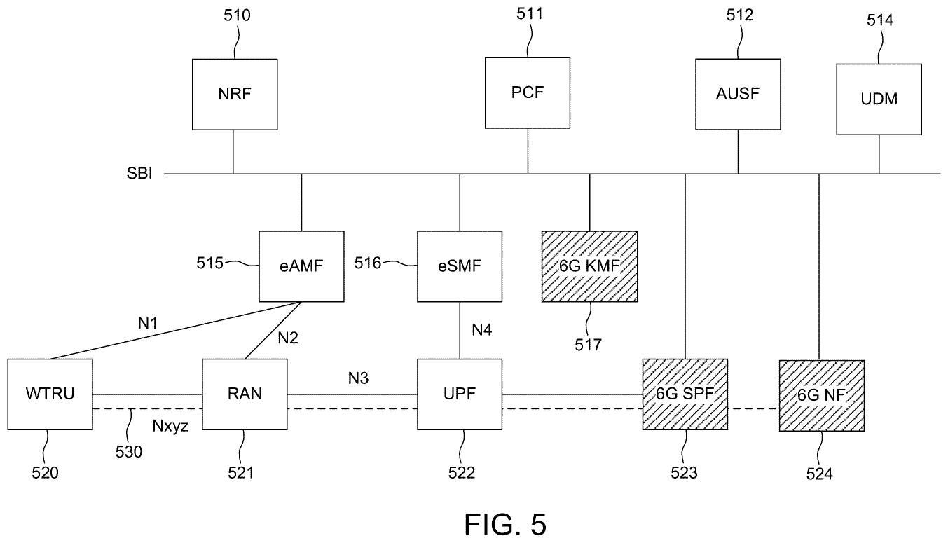

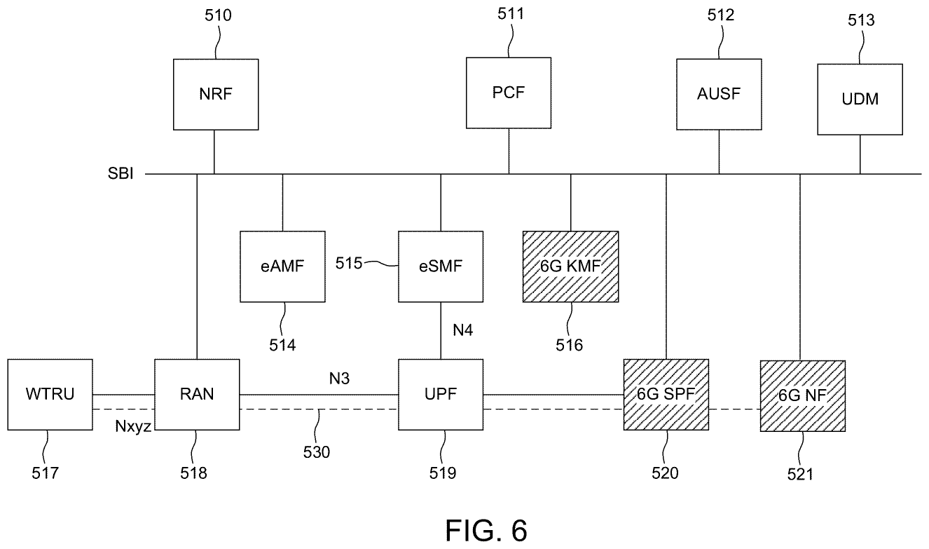

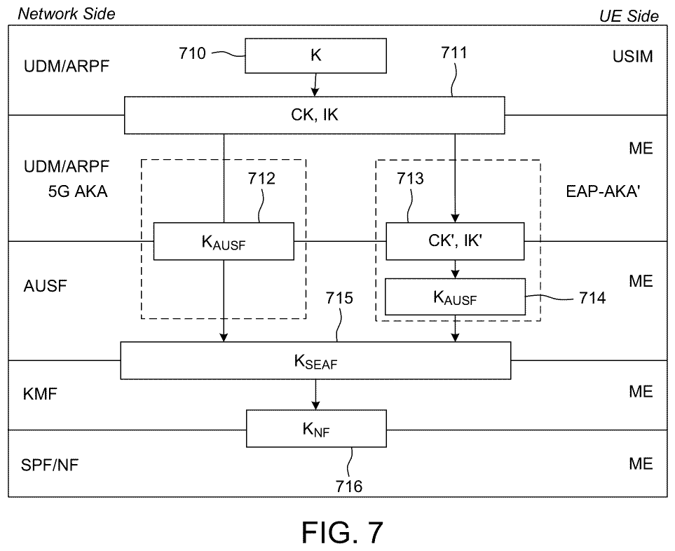

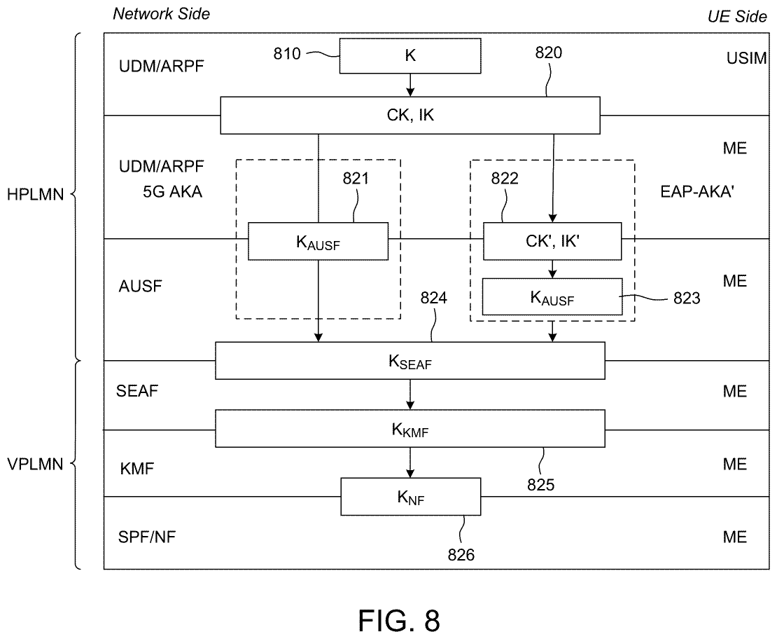

FIGS. 5 and 6 illustrate example architectures of systems to support secure end-to-end WTRU-NF communications. FIGS. 7 and 8 illustrate key distribution. FIG. 5 illustrates an example hybrid system architecture for WTRU-NF communication. The following functions are shown in FIGS. 5 and 6. NRF 510, PCF 511, AUSF 512, UDM 514, eAMF 515, eSMF 516, 6G KMF 517, WTRU 520, RAN 521, UPF 522, 6G SPF 523, 6G NF 524. In embodiments, the WTRU 520 uses a conventional N1 interface for CP-terminated communication with legacy/evolved 5GS functions (for example, MM, SM, PCF). In embodiments, the WTRU communicates using UP-based communications via UPF 522 with applicable new 6G NFs (for example, data collection, sensing, and positioning).

FIG. 6 illustrates an example system architecture for WTRU-NF communication. The difference from the “hybrid” architecture shown in FIG. 5, is that the WTRU 627 uses the RAN 618 as an SBI gateway for CP-terminated communications.

Embodiments for functionality (SPF, KMF) introduced in the example architecture described above are further described below.

The SBI Proxy Function or Security Proxy Function (6G SPF or SRPF) is described herein.

In embodiments, the SPF acts as a reverse proxy towards 6G NFs on the SBI. The SPF forwards requests/responses between the WTRU and NFs. In embodiments, the SPF may provide a security termination point for WTRU communication with the NF. In embodiments, the SPF may provide network topology hiding (from WTRUs, outside the network). In embodiments, the SPF may provide support for 6G NF discovery and selection to allow the WTRU to connect with the NF.

In embodiments, the SPF is in the path between the UPF and NF for UP-based communications. Similarly, the RAN may use SPF (not shown in the figures) as a security termination point for CP-based communication. As such, SPF abstracts 6GC NFs discovery/selection from the RAN. In embodiments, the SPF may be co-located with the UPF, RAN, or other proxy NF such as SCP. In embodiments, the SPF may be co-located or play the role of a Security Gateway to provide unified access to network services (over SBI) to the WTRU connecting via 3GPP or non-3GPP (for example, WiFi) access.

In embodiments, The SPF addressing info (e.g., FQDN) may be pre-configured in the WTRU or preconfigured in the RAN. The SPF addressing info may be provided to the WTRU, by the network (for example, during a registration, or PDU Session establishment procedure). Alternatively, the SPF address/NF Id may be provided by the RAN, for example, based on the NF the WTRU wants to contact. In embodiments, the WTRU may discover the SPF addressing info. For example, the WTRU may construct an SPF address info based on a serving PLMN name.

The 6G Key Management Function (6G KMF) is described herein.

In embodiments, the KMF provides a network key management service (for example, SBI service) to NFs and WTRUs (for example, key generation, distribution, revocation). The KMF may provide key material used for establishing secure communications between the WTRU and the NF. Using KMF service operations, each NF can establish a security association with the WTRU, independent of other NFs'security associations.

In embodiments, the KMF may be deployed in VPLMN and HPLMN to provide differentiated security at the VPLMN and HPLMN. For example, with KMF deployed in HPLMN, the system provides means for end-to-end secure communications between WTRU and NF in HPLMN (for example, for Policy provisioning, SoR). In embodiments, the KMF located in the HPLMN may provide for more operator control of WTRU-NF E2E secure communications. In embodiments, the KMF may be co-located with other functions (for example, AMF, SEAF, AUSF).

In embodiments, the KMF may provide key distribution over the UP to the WTRU. The WTRU may request key material from the KMF over a secure connection over UP (for example, using GBA, AKMA). The WTRU sends the authorization token request to the KMF along with the NF/AF ID, resource requested, token lifetime duration. The KMF requests information from resource owner/server (identified by NF/AF ID) and other NFs such as PCF and UDR/UDM to make authorization decision on if the requested token with scope can be permitted. Upon authorizing the resource access request, the KMF derives an authorization token with scope (for example resource, granularity, duration) that is digitally signed using the private key of the KMF. The KMF then sends the authorization token back to the WTRU.

If the ID token is requested from the WTRU, the KMF derives the ID token for the WTRU that is compliant with OIDC and sends the ID token back to the WTRU along with the authorization token.

FIGS. 7 and 8 illustrate example key hierarchies for the support of secure end-to-end communications between the WTRU and the NF. FIG. 7 is an example key hierarchy for end-to-end (E2E) communications between a WTRU and NF in HPLMN. FIG. 8 is an example key hierarchy for E2E Communications between a WTRU and NF in VPLMN. FIG. 7 includes shared secret key K, 710, cypher key and integrity key CK, IK 711, K_{AUSF} 712, CK′, IK′ 714, K_{SEAF} 715 and K_{NF} 716. FIG. 8 includes shared secret key K, 810, cypher key and integrity key CK, IK 820, K_{AUSF} 821, CK′, IK′ 822, K_{SEAF} 824, K_{KMF} 825, and K_{NF} 826.

Following successful primary authentication, in embodiments, the AUSF or SEAF may provide the KMF with a root key (K_{KMF}) and associated unique key identifier (K_{KMF} ID) used as a root of security for communications between the WTRU and NFs. The K_{KMF} may be derived from an anchor key (for example, K_{SEAF} if derived at SEAF) or an intermediate key (KAUSF if derived at AUSF). An example of a key derivation function for K_{KMF} may be: K_{KMF}=KDF (K_{AUSF} or K_{SEAF}, SUPI, <string>), where SUPI is the long-term identity of the WTRU and <string>indicates a standardized string for the Network Key Management Service (NKMS) feature enabled with KMF, for example, “NKMS”.

To be able to locate the K_{KMF} in the KMF, in embodiments, the key identifier K_{KMF} ID may be derived to ensure its uniqueness in the KMF. For example, K_{KMF} ID may be cryptographically bound to the WTRU or subscription identity. An example of a key derivation function for K_{KMF} ID may be: K_{KMF} ID=KDF (K_{AUSF} or K_{SEAF}, SUPI, <string>), where SUPI is the long-term identity of the WTRU/subscription and <string> indicates a standardized string, for example, “KMF-TID.”

When the KMF receives a WTRU token request from the WTRU along with the NF/AF ID, resource requested, token lifetime duration, the KMF/NRF collaborate with resource owner/server (identified by NF/AF ID) and other NFs such as PCF and UDR/UDM. The KMF first checks the WTRU ID and authorization using credentials derived from the primary access authentication for the resource access request, the KMF derives authorization token with scope (for example, resource, granularity or duration) that is digitally signed using the private key of the KMF/NRF. The KMF/NRF then sends the authorization token back to the WTRU.

If the ID token is requested from the WTRU, the KMF may derive the ID token for the WTRU that is compliant with OIDC and send the ID token back to the WTRU along with the authorization token in the previous step.

In embodiments, the WTRU derives an ID token with information such as PDU session ID, WTRU ID, termination point information, the freshness parameter, and the service duration, signed using a key K_Auth derived from the K_{KMF}. In embodiments, the ID token may be validated by the KMF or other NF using the key K_Auth derived from the K_{KMF} by the KMF. This ID Token validation can be performed by the KMF when it receives the validation request from a NF that need to authenticate the WTRU using the ID Token derived by the WTRU. Alternatively, the key K_Auth that is derived from the K_{KMF} can be delivered to the NF that use the key to validate the ID token for the WTRU authentication.

6GS enables secure end-to-end communication between a WTRU and an NF in the Core Network (6GC) and an AF outside the 6GC. The WTRU may use the authentication and authorization token to establish a secure connection with the NF/AF after the token validation. The authentication and authorization tokens are requested from and issued by the KMF/NRF after the primary authentication. An alternative embodiment to authentication token issued by the KMF/NRF is that WTRU derives an ID token using a key that is derived from K_{KMF} both by the WTRU and KMF. A secure tunnel between the WTRU and the NF may be established using server side credential such as public certificate. The ID token and authorization token may be used for the WTRU authentication and authorization.

After primary authentication with the core network, both the WTRU and the KMF in 6GC derive K_{KMF}. When triggered, the WTRU sends a request to the KMF for the Authentication and Authorization tokens with NF/AF ID, resource to access, scope, duration, and other information.

In embodiments The KMF may authenticate the WTRU and authorize the access request based on the NF profile, resource to be accessed, WTRU info in UDM/UDR, security policy in PCF, and may contact the NF/AF if needed for authorization information on the WTRU. The KMF may retrieve the NF profile from the NRF using the NF ID. If the WTRU is authorized, the KMF generates the authentication and authorization token and respond back to the WTRU with token that includes parameters such as scope, token type, lifetime of the access token or refresh token.

In a further embodiment, the WTRU sends a token request to the KMF, and the KMF request authentication and authorization token from the NRF on behalf of UE. In further embodiments, the WTRU may request the authentication and authorization token directly from the NRF that can perform the same functionality as KMF and derive the requested tokens upon authorization and authentication of the WTRU.

An alternative embodiment to requesting the authentication token from KMF/NRF is for the WTRU to generate the ID token using the session ID, the WTRU ID, and a time stamp using an key derived from the KKMF shared with the KMF. When a NF or third party AF receives the ID token from the WTRU, it then authenticates the WTRU by requesting the validation of the token by the KMF.

In embodiments, the WTRU sends a resource request to NF/AF using the authorization and authentication tokens to make requests to the NF/AF (for example, acting as a resource server or front end interacting with a resource server on behalf of the WTRU) with authorization token in the authorization header. The resource server validates the authentication and authorization token for the resource requested, and responds with the requested resource upon validation. The NF/AF may contact the token issuer KMF for token validation if needed.

Example authentication and authorization tokens are described herein.

Examples of identity and authorization tokens used by the WTRU for direct communication with NFs are described below. In embodiments, tokens may contain one more claims not shown below and may be encoded in a compact form for exchange between the WTRU and 6GC (e.g., as JSON Web Tokens—JWTs).

### Sample OIDC (OpenID Connect) Authentication Token (as a JWT)

This token may be issued to the WTRU, that can be used for authentication with an NF/AF. OIDC builds on top of OAuth 2.0 and adds an identity layer.

{

| | |
|---|---|
| “iss”: “https://kmf.example.com”, | // Issuer of the token (KMF) |
| “sub”: “SUPI:123456789012345”, | // Subject (UE identifier) |
| “aud”: “nf.example.com”, | // Audience (Target NF/AF) |
| “exp”: 1651234567, | // Expiration time (Unix timestamp) |
| “iat”: 1651230967, | // Issued at time (Unix timestamp) |
| “auth time”: 1651230900, | // Time when the user was authenticated |
| “nonce”: “n-0S6_WzA2Mj”, | // Nonce for replay protection |
| “amr”: [“password”], | // Authentication methods used |
| “aci”: “urn:3gpp:5gc:amf”, | // Access control information (e.g., originating AMF) |
| “scope”: “openid profile” | // Scopes related to identity information |

}

The above is just the payload of the JWT. The token may include a header, this payload, and a signature, all base64url encoded and separated by dots.

### Example OAuth 2.0 Authorization Token (as a JWT)

This token may be issued to the WTRU to authorize access to resources of NF/AF.

{

| | |
|---|---|
| “iss”: “https://kmf.example.com”, | // Issuer of the token (Authorization Server) |
| “sub”: “ue.example.com”, | // Subject (Requesting WTRU identifier) |
| “aud”: “Imf.example.com”, | // Audience (Target NF/AF - Resource Server, e.g., LMF, NWDAF) |
| “exp”: 1651238167, | // Expiration time (Unix timestamp) |
| “iat”: 1651234567, | // Issued at time (Unix timestamp) |

“scope”: “nudm-sdm:read nudm-uecm:update”, // Granted scopes (access permissions)

| | |
|---|---|
| “client_id”: “ue-client”, | // Identifier of the requesting WTRU |
| “grant_type”: “client_credentials” | // Type of grant used to obtain the token |

}

In embodiments. the “scope” parameter, above, may be expanded for fine-grain resource control purpose, action, duration, etc. Similar to the authentication token, this is the payload of a JWT and the complete token would include header and signature components.

These examples only illustrate the kind of information contained within these tokens, which are crucial for establishing secure and fine-grained access control in the evolving 6G service-based architecture. The exact format and claims are not limited to these examples.

Example processes for end-to-end WTRU connection with an NF/AF using authentication and authorization token are described herein.

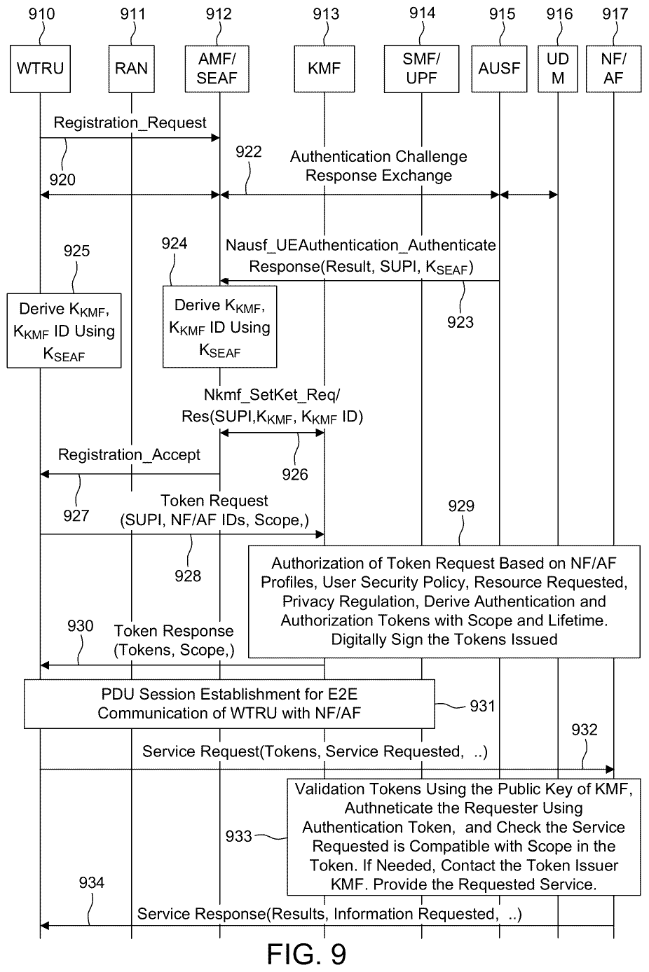

FIG. 9 illustrates an example procedure to establish an end-to-end connection between the WTRU 910 and an NF/AF 917 after successful validating the authentication and authorization token presented by the WTRU. First, WTRU and network (for example, SEAF) generate a root key K_{KMF} following a successful primary authentication. Upon request, the KMF provides the WTRU with authentication and authorization token for the NF/AF resource access if the WTRU is authorized to access resources. The WTRU requests the service and fine grain resource access along with the authentication and authorization token and WTRU is authenticated by the NF/AF by validating the authentication token issued either by the KMF/NRF, or the WTRU self generates an ID token.

At 920, the WTRU 910 performs a primary authentication with the network (for example, AKA or EAP-AKA′).

Upon successful completion of the authentication 922, at 923 the AUSF 915 sends to SEAF 912 the result of the authentication, the SUPI, and a K_{SEAF}.

At 925, 924 the WTRU 910 and AMF/SEAF 912 derive a new K_{KMF} and K_{KMF} ID using K_{SEAF}.

At 926, the SEAF sends a request message to KMF including the SUPI, K_{KMF}, and K_{KMF} ID. KMF stores the SUPI, K_{KMF}, and K_{KMF} ID in a Key Management Context for the WTRU, and the KMF sends a response message to AMF/SEAF including the list of NFs information.

At 927, the AMF/SEAF 912 sends a Registration Accept message to the WTRU including the list of NFs information. Alternatively, the WTRU may receive the list of NFs information from a PCF that may be sent to the WTRU during other procedures (for example, in WTRU Configuration Update (UCU)).

At 928, the WTRU sends a token request to the KMF 913 (for example, over CP, via RAN/AMF) for the Authentication and Authorization tokens with NF/AF ID, resource to access, scope, duration, and other information. In embodiments the token request may include: Identifier of the target NF/AF (the Resource Server), the specific scopes or permissions being requested (defining the level of access needed), user identifier (e.g., SUPI), grant type (for example, client credentials for NF-to-NF internal access, authorization code or other flows if involving a WTRU context). Note: the message is protected by NAS security is CP is used. Or any PSK produced from AKMA after the primary access authentication. In embodiments, the WTRU may construct a message containing a WTRU ID, a unique session ID, a timestamp, and, optionally, application-specific claims. The WTRU may then calculate a MAC (for example, using HMAC-SHA256 with K_Auth that is derived from the K_{KMF}) over this message. The token sent to the NF/AF is the message concatenated with the MAC.

At 929, the KMF authenticates the WTRU and authorize the access request based on the NF/AF profile, resource to be accessed, WTRU info in UDR, security policy in PCF, and may contact the NF/AF if needed for authorization information on the WTRU. The KMF authenticates the requesting NF/AF using its client credentials and evaluates the requested scopes against the policies and the identity of the requesting NF/AF (and the WTRU, if applicable), ensures the requesting NF/AF is authorized to request the specified scopes for the target NF/AF and the associated user.

At 930, if the WTRU is authorized, the KMF 913 derives the authentication and authorization token. This token may contain claims about the granted scopes, the identity of the requesting NF/AF (and potentially the WTRU), and an expiration time. In embodiments, the KMF may also issue a refresh token to allow the requesting NF/AF to obtain new access tokens without re-authenticating. The KMF respond back to WTRU with scope parameter, token type, lifetime of the access token, or refresh token. In embodiments, the WTRU may receive a root certificate used to authenticate the NF/AF when establishing secure communication with NF in the next steps. In an alternative to the refresh token, the WTRU may issue a new access token request without re-authentication since the WTRU is authenticated to communicate over secure channel with KMF

At 931, UP secure connection setup WTRU-NF using PDU Session, root certificate from KMF is performed. The end to end connection of WTRU-NF/AF may be based on the mechanisms such as PSK or server side certificate. The authentication token such as OIDC or WTRU self-signed ID token will be used for the WTRU authentication by the NF/AF. The authorization token may be used by the NF/AF for fine-grain access authorization of WTRU request.

At 932, the WTRU may send a resource request to the NF/AF using the access token to NF/AF to make requests to the resource server with authorization token in the authorization header.

At 933, the resource server validates the access token and responds with the requested resource upon validation. The NF/AF may validate the token then perform the action on the resource server. The NF/AF may be itself the resource server (for example, a data collection function to receive and store data from the WTRU) and perform the action locally. For a WTRU self-generated authentication token (as described at 928), upon receiving the token, the NF/AF extracts the message and recalculates the MAC using its K_Auth that is requested from the KMF using the WTRU ID. If the calculated MAC matches the one received in the token, the NF/AF verifies the integrity and authenticity of the message, implicitly authenticating the WTRU for that session.

At 934, the NF/AF performs the requested service and responds to the WTRU with service results.

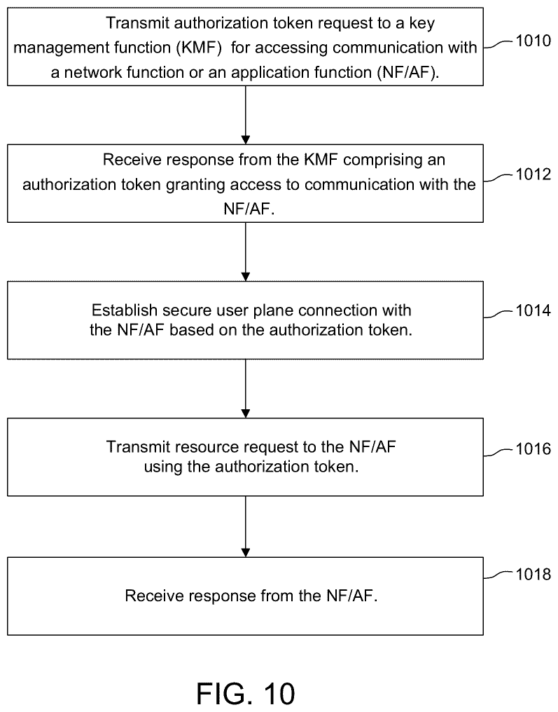

FIG. 10 is a flow chart of an example process for establishing a WTRU connection with an NF/AF using authentication and authorization token. At 1010 the WTRU transmits an authorization token request to a key management function (KMF) for accessing communication with a network function or an application function (NF/AF). At 1012,the WTRU receives a response from the KMF comprising an authorization token granting access to communication with the NF/AF. At 1014, the WTRU establishes a secure user plane connection with the NF/AF based on the authorization token. At 1016, the WTRU transmits a resource request to the NF/AF using the authorization token; and At 1018 receives a response from the NF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
transmitting an authorization token request to a key management function (KMF) for accessing communication with a network function or an application function (NF/AF);
receiving a response from the KMF comprising an authorization token granting access to communication with the NF/AF;
establishing a secure user plane connection with the NF/AF based on the authorization token;
transmitting a resource request to the NF/AF using the authorization token; and
receiving a response from the NF/AF.

2. The method of claim 1, wherein the authorization token request includes at least one of: an NF/AF identification (ID), a resource to access, scope of the resource request, or duration of the resource request.

3. The method of claim 1, wherein the authorization token includes at least one of: a granted scope of the requested resource, the NF/AF ID or an expiration time of the requested resource.

4. The method of claim 1, wherein the response from the KMF further comprises a refresh token.

5. The method of claim 1, wherein the response from the KMF further comprises at least one of a scope parameter, a token type, a token lifetime.

6. The method of claim 1, wherein the response from the NF/AF includes results of a service requested by the WTRU.

7. The method of claim 1, further comprising: the WTRU performing a primary authentication with the network prior to transmitting the authorization token request.

8. The method of claim 7, further comprising receiving from the KMF a root key and a unique key identifier.

9. The method of claim 1, further comprising:
requesting an authentication token from the KMF; and
receiving the authentication token.

10. The method of claim 1, further comprising:
generating an authentication token based on a session ID, a WTRU ID and a time stamp using a key derived from a key (K_{KMF}) shared with the KMF.

11. A wireless transmit/receive unit (WTRU) comprising:
a processor and
a transceiver, wherein the processor and transceiver are configured to:
transmit an authorization token request to a key management function (KMF) for accessing communication with a network function or an application function (NF/AF);
receive a response from the KMF comprising an authorization token granting access to communication with the NF/AF;
establish a secure user plane connection with the NF/AF based on the authorization token;
transmit a resource request to the NF/AF using the authorization token; and
receive a response from the NF/AF.

12. The WTRU of claim 11, wherein the authorization token request includes at least one of: an NF/AF identification (ID), a resource to access, scope of the resource request, or duration of the resource request.

13. The WTRU of claim 11, wherein the authorization token includes at least one of: a granted scope of the requested resource, the NF/AF ID or an expiration time of the requested resource.

14. The WTRU of claim 11, wherein the response from the KMF further comprises a refresh token.

15. The WTRU of claim 11, wherein the response from the KMF further comprises at least one of a scope parameter, a token type, a token lifetime.

16. The WTRU of claim 11, wherein the response from the NF/AF includes results of a service requested by the WTRU.

17. The WTRU of claim 11, wherein the processor and transceiver are further configured to performing a primary authentication with the network prior to transmitting the authorization token request.

18. The WTRU of claim 17, wherein the processor and transceiver are further configured to receive from the KMF a root key and a unique key identifier.

19. The WTRU of claim 11, wherein the processor and transceiver are further configured to:
request an authentication token from the KMF; and
receive the authentication token.

20. The WTRU of claim 11, wherein the processor and transceiver are further configured to generate an authentication token based on a session ID, a WTRU ID and a time stamp using a key derived from a key (K_{KMF}) shared with the KMF.
